(19) United States
(12) Patent Application Publication
(10) Pub. No.: US 2026/0127551 A1
(43) Pub. Date: May 7, 2026

(54) Candidate Evaluation System Using a Consensus Reference

(71) Applicant: Talent Select AI, Milwaukee, WI (US)

(72) Inventors: Marc Fogel, Simsbury, CT (US); Georgia Galanopoulos, Vineland, NJ (US); Stuart Olsten, Milwaukee, WI (US); William Rose, El Paso, TX (US)

(21) Appl. No.: 18/937,606

(22) Filed: Nov. 5, 2024

(51) Int. Cl. G06Q 10/1053; G06Q 10/0631

(52) U.S. Cl. CPC G06Q 10/1053; G06Q 10/063112

(57) ABSTRACT

An apparatus for assisting in the evaluation of candidates identifies important traits and characteristics for particular jobs using multiple sources of job-related information. A rating ranking identifying the most important traits and characteristics may then be used for evaluation of candidate materials for the particular job.

### STATEMENT REGARDING FEDERALLY SPONSORED RESEARCH OR DEVELOPMENT

NA

### CROSS REFERENCE TO RELATED APPLICATION

NA

### BACKGROUND OF THE INVENTION

The present invention relates to systems and methods for evaluating candidates for employment and the like and, in particular, to a system that provides a consensus-based reference for evaluating candidates to provide improved candidate ranking with reduced risk of bias.

The recruitment of employees or similar candidates is important for businesses and institutions. Such recruitment efforts normally focus on objective skills, for example, typing ability and other types of domain knowledge, as well as so-called traits and competencies reflecting a candidate's personality, for example, with respect to agreeableness or conscientiousness.

Traits and competencies are particularly difficult for a human recruiter to assess and quantify; however, systems to assist in this process have been developed. U.S. patent application Ser. No. 17/236,784 entitled: “System and Method For Evaluating Candidates, Such as Candidates for Employment or University Admission, or Employees or Other Approved Candidates”, and U.S. patent application Ser. No. 18/157,543 entitled: “Position-Resolved, Broad Engagement, Candidate Matching System”, assigned to the assignee of the present application and hereby incorporated by reference, describe systems and methods that can review written or transcribed interview material and assess individuals with respect to multiple different categories of traits and competencies.

Assessing an individual's traits and competencies raises the problem of how to determine the necessary traits and competencies required for a particular position. Accurately determining the necessary traits and competencies for a position is particularly important to the extent that there may be a tendency to determine that all positive traits are important for the job, and in this process “water down” the value of focusing on what is truly most critical for job success. For example, while it may be helpful for a retail salesperson to be skilled at seeking new ideas and solving problems creatively, their ability to support and show respect to customers is more important for success on the job.

### SUMMARY OF THE INVENTION

The present invention provides a consensus-based system for producing a quantitative description of desirable traits and competencies for a given job. This quantitative description can be provided to a candidate evaluation system, for example, as described above, or be used by a human recruiter in assessing candidates. By combining multiple independent sources describing a particular job, including both descriptions developed from within the organization and by external third parties, a more reliable and bias resistant set of metrics for a given position can be developed.

In one example, the invention provides an apparatus for evaluating candidates for a target position having an input for receiving information describing qualifications for a given job from multiple different sources including at least one text job description. A text processor processing the at least one text job description provides numeric scores for predefined traits and competencies related to the at least one text job description. Numeric scores from multiple different sources are then received by a threshold processor to identify a subset of the predefined traits and competencies for the given job most related to the given job. This subset is provided to a candidate evaluation module together with candidate information to evaluate the candidates against the subset of the predefined traits and competencies.

It is thus a feature of at least one embodiment of the invention to provide a systematic way of identifying traits and competencies strongly associated with the given job position to guide candidate assessment systems.

The threshold processor may normalize the numeric scores within each of the different sources and combine them statistically to produce a ranking to select the subset of the traits and competencies for the given job from the highest ranked traits and competencies.

It is thus a feature of at least one embodiment of the invention to facilitate the integration of job-related information from different sources by compensating for source-dependent biases.

The threshold processor may statistically combine numeric scores from each of the different sources as a function of the number of different sources reporting scores for each of the traits and competencies.

It is thus a feature of at least one embodiment of the invention to compensate for missing scores from particular sources in the combination process.

The apparatus may include a variance analyzer for identifying predetermined traits and competencies from the different sources that have numeric scores that differ from a statistical combination of the numeric scores and provide an indication to an operator that the identified numeric scores require additional review.

It is thus a feature of at least one embodiment of the invention to increase visibility of the assessment process to encourage operator review when there is a wide difference between assessments from different sources.

The text processor may include a dictionary of terms linked to the traits and competencies and may analyze text from at least one source of the multiple different sources using the dictionary to establish a numeric score for the at least one source.

It is thus a feature of at least one embodiment of the invention to provide a way of converting text descriptions commonly available from multiple sources into numeric measures of traits and competencies.

One source may be a recruitment job description prepared by an institution seeking a candidate for the given job.

It is thus a feature of at least one embodiment of the invention to make use of pre-existing documents normally prepared for recruitment purposes.

At least one source may be a government-produced standard job description.

It is at least one feature of at least one embodiment of the invention to provide an objective measure coming from outside of the institution.

In some embodiments, the government-produced standard job description may be from the O*NET database.

It is thus a feature of at least one embodiment of the invention to provide a government-sanctioned job description presumed to be professionally created and legally defensible.

The apparatus may further include a questionnaire-collating system receiving input from multiple individuals to rate the given job with respect to the predefined traits and competencies to provide numeric scores to the threshold processor.

It is thus a feature of at least one embodiment of the invention to provide a direct assessment of traits and competencies rather than an assessment inferred from text job descriptions.

The questionnaire collating system may provide a server serving a questionnaire to multiple computer terminals associated with different individuals.

It is thus a feature of at least one embodiment of the invention to greatly facilitate collecting questionnaire input from multiple individuals to produce a consensus-based assessment.

The threshold processor may further include an experience weight input receiving information about successful candidates and their associated traits and competencies to adjust weights attached to each of the traits and competencies serving the scale of the numeric rankings of these traits and competencies.

It is thus a feature of at least one embodiment of the invention to provide a system that can learn from actual experience with candidates.

These particular objects and advantages may apply to only some embodiments falling within the claims and thus do not define the scope of the invention.

### BRIEF DESCRIPTION OF THE DRAWINGS

FIG. 1 is a simplified diagram of an example set of hardware components suitable for implementing the candidate evaluation system of the present invention;

FIG. 2 is a functional block diagram of the operation of the hardware components of FIG. 1 operating to evaluate multiple job descriptions to develop a reference against which to evaluate candidates, and to provide candidate evaluation using that reference;

FIG. 3 is a screenshot of a first portion of a sample subject matter expert (SM E) questionnaire providing one source of input with respect to a developed reference for candidate evaluation;

FIG. 4 is a figure similar to that of FIG. 3 showing a second portion of the questionnaire identifying must-have traits and an evaluation of negative expression of emotion; and

FIG. 5 is a table illustrating the operation of the threshold functional block in combining references from different sources to identify a subset of qualifications for candidate valuation.

### DETAILED DESCRIPTION OF THE PREFERRED EMBODIMENT

### I. Building an Evaluation Reference

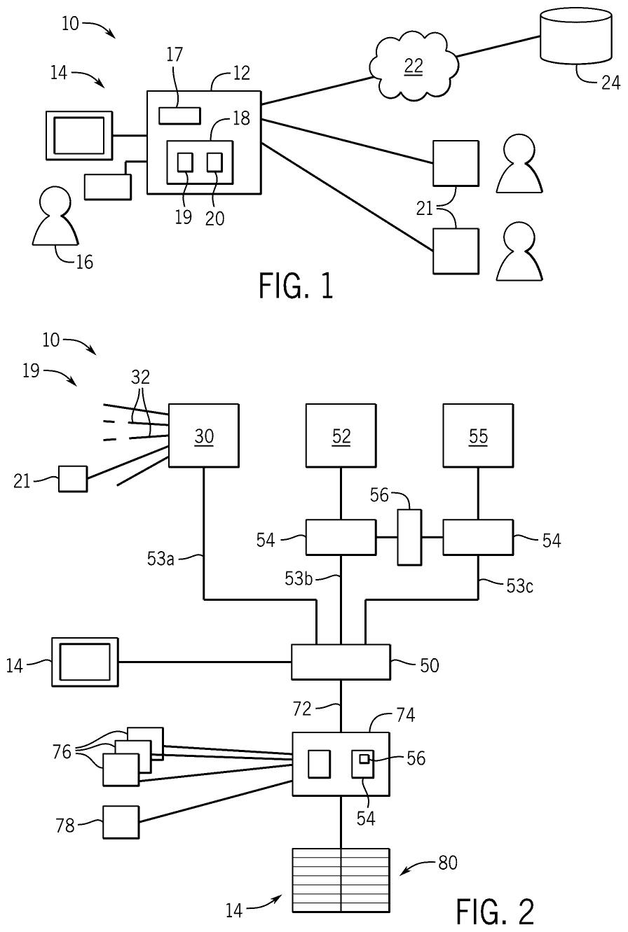

Referring now to FIG. 1, an apparatus for evaluating employment candidates 10 may, in one embodiment, provide for a central evaluation computer 12 communicating via a user interface 14 with an evaluator 16 conducting an evaluation of employment candidates.

In this regard, the user interface 14 may provide for a computer monitor providing text and graphic output and a keyboard, mouse, or the like, for receiving input from the evaluator 16. The computer 12 may further provide other means of input, for example, through the Internet 22, removable memory devices, or the like.

The computer 12 will generally include one or more electronic processors 17 communicating with electronic memory 18, the latter holding a stored program 19 and data files 20 whose operation will be described below.

Various additional interface devices 21, for example, remote terminals used by other individuals similar to interface 14 within the institution of the evaluator 16 or by candidates for positions with the institution, may also be attached to the computer 12 through a network connection. Network connections also allow the computer 12 to communicate with remote sites 24, such as O*NET, an online repository of occupational information sponsored by the US Department of Labor/Employment.

Referring now also to FIG. 2, the program 19 may operate to receive data related to a given job subject to recruitment from multiple different sources including from an online questionnaire system 30, a remote site such as O*NET 52, and an internally prepared job description 55, intended, for example, for posting, as will each be described. Each of these sources will be used to develop a list of important traits and competencies for the particular job.

The questionnaire system 30 will generally communicate with multiple individuals within the institution posting the job, for example, using interface devices 21 which may display a questionnaire and collect and return responses. These questionnaires are sent to individuals with subject matter expertise (SME) related to and identified by job category of a position that needs to be filled by the institution. Those individuals may, for example, be high performing job incumbents, people who used to work in the job or supervisors of job incumbents.

Individuals solicited for input via the questionnaire system 30 receive a survey form 32 that may be displayed on an interface device 21. The survey form 32 generally provides a first portion (not shown) allowing the subject matter expert to identify himself or herself, their own job titles, and to confirm or identify the particular job being evaluated.

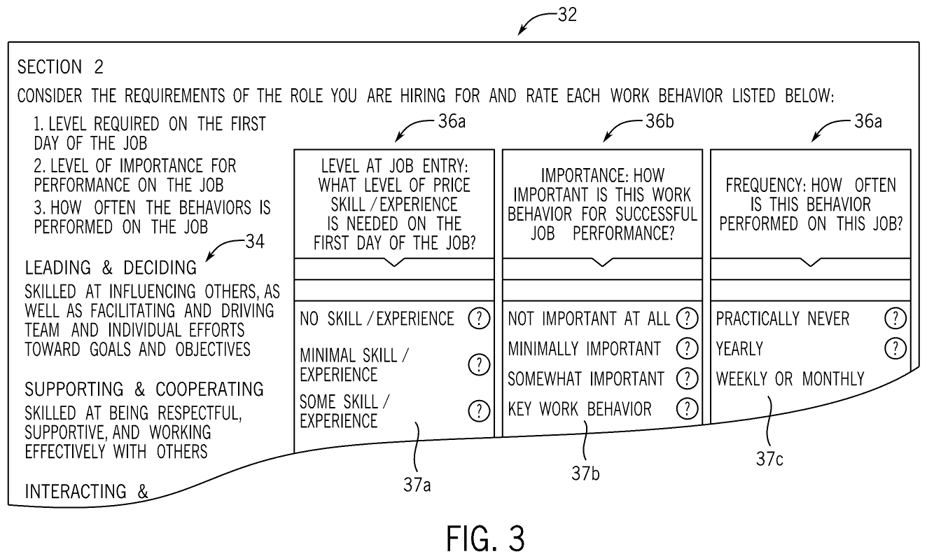

Referring now also to FIG. 3, a second section of the survey form 32 shown in one example provides, in a first column, important traits and competencies 34 and a short description of each trait and competency, With respect to each trait and competency of the first column, the survey form 32 provides drop-down menus 37a, 37b, and 37c allowing the surveyed individual to rate each of those traits and competencies with respect to: (1) how important the trait or competency is at the beginning of employment per first column 36a, (2) how important the trait or competency is for continued successful job performance per second column 36b, and (3) how frequently this trait or competency is required during the job per third column 36c.

In one nonlimiting example, the particular competencies may include eight widely applicable competencies of:
Leading and deciding,
Supporting and cooperating,
Interacting and presenting,
Analyzing and interpreting,
Creating and conceptualizing,
Organizing and executing,
Adapting and coping, and
Enterprising and performing.

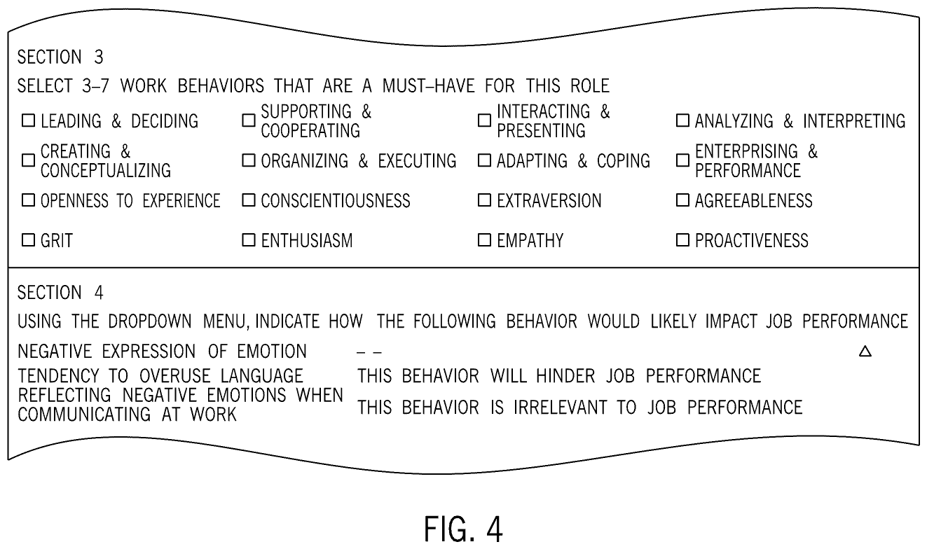

In addition, nine work-fit enhancing traits are evaluated including the five personality traits of:
Openness to experience,
Conscientiousness,
Extroversion,
Agreeableness, and
Negative expression of emotion (provided in a separate section shown in FIG. 4). These 5 personality traits generally are similar to those defined in the OCEAN personality framework incorporated by reference.

Finally, additional motivational traits are provided of:
Enthusiasm,
Empathy,
Proactiveness, and
Grit.

The final motivational trait of Grit may include subcategories of
Sustained dedication
Resilience
Self-determination, and
Delayed gratification.

Generally these traits and competencies describe job independent personal qualities that are either natural preferences and/or can be learned or practiced.

The selections made by each surveyed individual will be mapped by the questionnaire system 30 to a preassigned numeric score (for example, 1-5) for that particular trait or competency. The questionnaire system 30 may then normalize the scores for each surveyed individual and combine the scores after normalization among different surveyed individuals, for example, by averaging, to obtain a consensus understanding of the necessary traits and competencies for the given job.

Referring to FIG. 4, a second portion of the survey form 32 may optionally allow the surveyed individual to identify a limited number of traits and competencies that are considered “necessary” (AKA “Must Have”) for the particular job being assessed. The numeric score for such identified traits and characteristics will then be moved to a high level independent of the previous selection by the surveyed individual (for example, overriding a numeric score of 4 with the numeric score of 5). This section of the survey form 32 may also provide for an input with respect to the Negative Expression of Emotion described above.

In one embodiment, the results from these surveys will be preprocessed to identify the most important traits and competencies as follows. If there are multiple survey responses, an aggregate is calculated by examining the percentage of responses that receive a rating of 3 or higher for Level at Entry (LAE) for each trait and competency (scale). In the rare event of having only one survey response, the calculation proceeds based on the raw scores (3 or higher) for each scale rather than examining percentages.

The responses are then subject to a first selection hurdle of selecting only scales where at least 50% of the SMEs have scored as a 3 or higher for the LATE scale. If 3 to 7 scales inclusive pass this hurdle, they are selected to be the critical scales for the assessment per process block 50 as will be described below, and preprocessing is complete.

If more than 7 scales pass this hurdle, the LAE scales are ranked by percentage and the scales that tie for 7th place are examined. Any tie is broken by ranking the percent of SMEs who have selected this scale as a Must Have and removing the bottom tie. If in this tie, the Must Have percentages are still tied, each scale's combined Importance and Frequency scores are examined to return a weighted score. The scale with the higher weighted score is then selected. If, once more, all tied scales have the same weighted score, then all the tied scales are removed from the survey's selection process.

If fewer than 3 scales pass the first selection hurdle, the Must Have percentages are ranked and the scales with the highest percentages are selected until 3 scales have been chosen in total. If more than 3 scales are selected because of a tie in Must Have percentages, the tied scales are examined. The tied scales' Importance and Frequency scores are combined to return a weighted score. The scale with the higher weighted score is then selected. If, once more, all tied scales have the same weighted score, then all the tied scales are added to the survey's selection process.

The only trait that does not follow this scoring method is Negative Expression of Emotion (NEE). For NEE, if there is only one survey response, the NEE score without additional calculations will be the final recorded value. In cases where there are multiple SMEs for a given role, the average of all SMEs' raw NEE scores will be used.

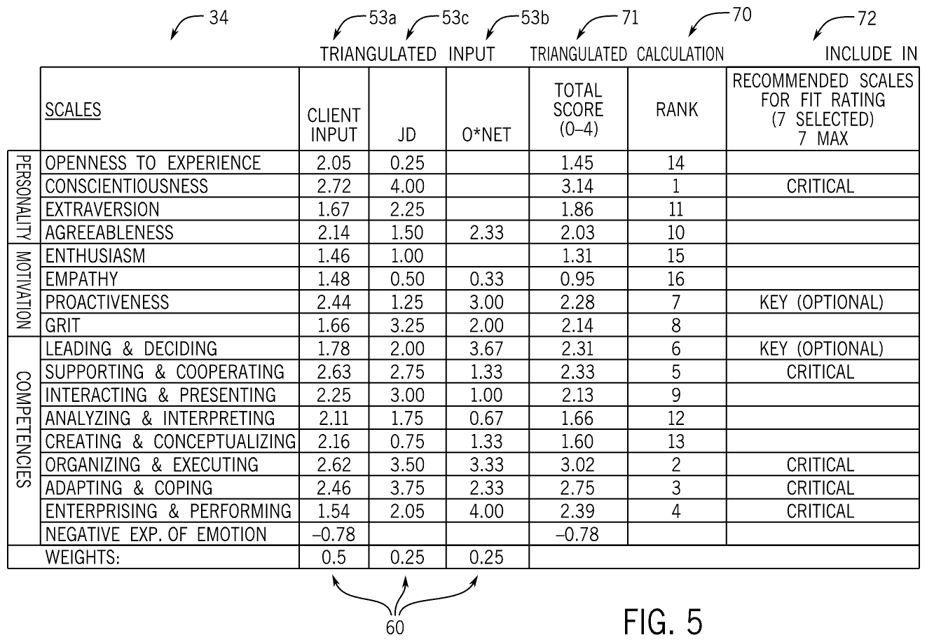

Referring to FIG. 4, the result is a list of the most important scales for this input and is depicted in FIG. 5 in the first and second column showing respectively example percentages and resulting ranking for each of these scales for the first hurdle.

Referring again to FIG. 2, a second source of information about the job for which recruitment is sought may be obtained from an internally prepared job description or job postings 55 normally used, for example, in recruitment materials and advertisements. An example such document prepared for an administrative assistant job may provide such descriptions as follows:

TABLE 1
Job Title: Administrative Assistant
Summary: The Administrative Assistant role provides support to their assigned team and
contributes to the smooth operation of the office. Successful incumbents are highly organized,
possess strong communication skills, and thrive in a fast-paced environment. This person plays a
crucial role in managing administrative tasks, coordinating schedules, and helping to facilitate
effective communication within the team, as well as with other teams, clients, and/or vendors.
Responsibilities:
Provide administrative support to ensure efficient operation of the office.
Assist in the coordination and execution of daily administrative tasks, including but not limited
to managing correspondence, scheduling appointments, and organizing meetings.
Maintain office supplies inventory by checking stock to determine inventory level, anticipating
needed supplies, and placing and expediting orders.
Handle incoming and outgoing communication, including emails, phone calls, and mail.
Prepare and edit documents, reports, and presentations as needed.
Assist in the organization and coordination of company events, meetings, and conferences.
Manage calendars and schedules, including arranging appointments and meetings.
Assist with travel arrangements and accommodations for staff.
Act as a point of contact between internal teams, clients, and external vendors.
Perform general clerical duties, such as filing, photocopying, and data entry.
Uphold a strict level of confidentiality and discretion in handling sensitive information.
Requirements:
Proven experience as an administrative assistant or relevant role.
Proficient in Microsoft Office Suite (Word, Excel, PowerPoint, Outlook).
Excellent organizational and time management skills.
Strong attention to detail and accuracy.
Exceptional communication skills, both written and verbal.
Ability to multitask and prioritize tasks effectively in a fast-paced environment.
Professional demeanor and interpersonal skills.
Ability to work independently and as part of a team.
High school diploma; additional qualifications in Office Administration are a plus.

In order for the job posts/descriptions to be scored in a meaningful manner, they are compared to a normative dataset developed from a corpus derived from O*NET, and in particular, O*NET's job titles and codes (specifically the first two digits of an occupational code referring to an occupation's job family, aka Code Family). O*NET is an online database sponsored by the U.S. Department of Labor, Employment & Training Administration, and developed by the National Center for O*NET Development. The corpus may be generated by web scraping more than 120,000 job posts hosted on the Indeed website. In order to ensure that most of the jobs in the U.S. labor market were represented in the corpus, job titles are randomly selected from O*NET's Alternate Job Title list (an extensive list of more than 50 k O*NET's job titles) with a target of 100 job posts per job title such as fluctuates depending on the title and the field.

The data of the job post/descriptions from O*NET is cleaned by removing job posts from the corpus with 250 words or less, or that were in non-English text or duplicates. The resulting corpus and the job posts and descriptions are then analyzed by the analysis module 54 which may, as described above, use the same or similar dictionary 56 and analysis module 54 to provide numeric score 53c. The analysis module 54 may use a variety of different techniques including but not limited to a machine learning module, a natural language processing model, and other similar neural network systems or the like. This analysis engine works in conjunction with a dictionary 56 to produce numeric score 53b for the traits and competencies, for example, analyzing the text from O*NET against the words of these dictionaries 56 using a TF-IDF (Term Frequency-Inverse Document Frequency) calculation to determine, on average, how common these terms are in the O*NET text based on the uniqueness of the words within the O*NET.

For each of the corpus's, job descriptions, the calculated percent (full) count and percent of the dictionary (binary count) per scale were summed. Percent count of a measurement scale refers to the percentage of scale-related words in a sample text, where scale-related words are the sum of all instances of each dictionary word present in the sample text. Percent of a dictionary (binary count) refers to the percentage of the dictionary used in a sample text, where scale-related words are calculated as a binary (1 or 0, either present in the sample text or not).

The percent full count of a job posting represents the amount of descriptive language in the posting that aligns with each measured scale. In other words, if the content in the entire job posting represents 100% of the job requirements, this analysis aims to answer this question: What proportion of the job requires each of the competencies and traits measured that will be assessed? For example, a job description that devotes 5% of its content to words that align with the competency of Supporting and Cooperating, could be presumed to be a job that requires more of this competency relative to a job description that devotes 1% of its content to this competency.

Combining the two analyses described above provides both a measure of the proportion of the job posting dedicated to each scale, as well as the proportion of the construct itself (defined by the entire word dictionary) represented in the job description.

Measurement scales that were seen to either lack variability in scores or did not appear appropriate for the purpose of analyzing the job posting as part of the triangulated job analysis process were excluded from the ranking process taking place during scoring. For example, the NEE trait will more than likely not be addressed in a job posting, thus it is excluded from the analysis. Another example is that Extraversion showed very little variability and was therefore also excluded.

Client job posts are analyzed similarly to the corpus, and the percent (full) count and the percent of the dictionary (binary count) per scale are summed so that each scale has a total percentage score. The resulting scores are transformed (if necessary) and normalized against the corpus's statistical values.

The normalized scores are then ranked among themselves, and the top 7 scales are selected for the final triangulation calculation per process block 50. FIG. 5 shows an example calculation where the job posting scale ranking are shown in the eighth column.

Referring still to FIG. 2, O*NET 52 or a similar external reference may provide a third source of a description of the job at issue used to extract numeric values indicating the importance of different traits and competencies. As noted above, O*NET provides over 50,000 individual job titles also referred to as Alternative Titles which are matched to the job at issue to obtain a prose description of that job type. For example, the following provides a short excerpt of the tasks performed by “Secretaries and Administrative Assistants, Except Legal, Medical, and Executive.”

TABLE II
Occupation tasks:
Answer telephones and give information to callers, take messages, or transfer calls to appropriate
individuals.
Greet visitors or callers and handle their inquiries or direct them to the appropriate persons according
to their needs.
Create, maintain, and enter information into databases.
Use computers for various applications, such as database management or word processing.
Operate office equipment, such as fax machines, copiers, or phone systems and arrange for repairs
when equipment malfunctions.

The O*NET materials provide general occupational skills but also information generally related to traits and competencies, for example, characterized as “work styles” which include characteristics such as dependability, cooperation, integrity, self-control and the like. In distinction from the direct output of numeric values from the questionnaire system 30, however, the information from O*NET provides only a general text description and does not provide information to directly produce a ranking of traits and competencies.

For this reason, the text information from O*NET is provided to an analysis module 54 that can process this text information to provide a numeric score similar to that provided for the job descriptions 55 discussed above. The only exception is that the O*-NET descriptions are normalized among themselves, while, for the job descriptions 55, the client-provided job descriptions are normalized against the job post corpus. In that way, the O*NET descriptions acted as their own corpus and each job title would retain its scores even if the client input changed. O*NET's list of occupation-specific tasks was used to represent the job requirements. The resulting rankings are shown in column nine of FIG. 5.

Referring now to FIG. 5, the traits and competencies indicated by each row of the table of FIG. 5 from each of the above described rankings may be used to provide a final ranking of critical scales. Desirably, the optimal number of critical scales is between 3-7. As such, if the client input survey 30 returns less than that number; the other two sources, namely the job description/posting 55 and O*NET, are examined and used to supplement the remaining critical scales.

If the client survey 30 provides all 7 critical scales, these scales will be considered the final critical skills. If the client survey provides fewer than 3 critical scales, the top O*NET scales and top Job Description scales are viewed. If both O*NET and the Job Description agree that a particular scale is critical, then that scale is selected to be considered as a final critical scale. The only time agreed-upon scales do not become final critical scales is when including all the agreed-upon scales leads to more than 7 total critical scales. In that scenario, only the client input scales are considered.

II Applying the Evaluation Reference against Candidates

The candidate evaluation engine 74 may receive text resumes or text transcriptions of interviews, providing interview data 76 for a variety of different candidates and may analyze those materials using an analysis module 54 and dictionary 56 similar or identical to the analysis module 54 and dictionary 56 described above with respect to data sources of O*NET 52 and job description 55. The result is a scoring of the candidate with respect to traits and competencies (scales) in the manner described in U.S. patent application Ser. No. 17/236,784 entitled: System And Method For Evaluating Candidates, Such As Candidates For Employment Or University Admission, Or Employees Or Other Approved Candidates, and U.S. patent application Ser. No. 18/157,543 entitled: Position-Resolved, Broad Engagement, Candidate Matching System.

Generally this output information may be displayed in a list indicating the candidates and their ranking based on how well they fit with the identified traits and characteristics indicated to be important for the job. A candidate's Fit Rating is a measurement designed to enable clients to quickly ascertain which candidates are more likely to be a good fit with the role. This rating is calculated by aggregating a candidate's scores for each of the critical scales identified via the above described process block 50. The statistical average of the critical scale scores represent the Fit Rating score, which ranges between 0 and 100. This Fit Rating score is then placed into one of five categories indicating the candidate's likely fit with the role per the following table:

TABLE IV

| Fit Rating | Score (Min) | Score (Max) |
|---|---|---|
| Insufficient Evidence | 0 | 19 |
| Weak | 20 | 39 |
| Moderate | 40 | 59 |
| Strong | 60 | 79 |
| Strongest | 80 | 100 |

It's important to note that scores that fall below a predetermined threshold receive a rating titled “Insufficient Evidence.” A very low score on any given scale could reflect one of two scenarios, First, it could reflect a situation where the interview questions did not address the topic, and the candidate did not bring it up on their own. Not bringing up a topic does not necessarily indicate a lack of the trait on the candidate's part; hence the rating name reflects this measurement's uncertainty. A second scenario is where a low score does in fact reflect a low degree of the competency or trait being measured. This is a scenario where we either know or have reason to believe that the topic was in fact addressed in the interview. For example, if a candidate was asked about their ability to respond to changes and manage work stressors, and they score low on the Adapting & Coping competency, it is more likely than not that the candidate possesses low levels of the competency.

When it comes to the calculation of the Fit Rating score, all critical scale scores (regardless of whether they fall in the “Insufficient Evidence” category or not) are included in the calculation of the Fit Rating score. This is due primarily to two reasons, First, given the importance and job-relevance of the critical scales, we operate under the assumption that topics related to these scales are addressed in the interview. Second, excluding the score from the Fit Rating calculation would unfairly disadvantage some candidates. For example, consider 2 candidates who score equally on all but one critical scale. On that scale, one candidate scores “Below Average” while the other's score is “Insufficient Evidence.” The Fit Rating score for the candidate who scored “Below Average” would be averaged down (assuming at least some of the other scales scored higher), while the candidate with the “Insufficient Evidence” score would stay as is, giving them an advantage.

Each candidate may be separately displayed with a quantitative indication of their rankings for each of the limited set 72 for individual comparisons. This latter form may be used to provide a deeper understanding of the necessary candidate qualities for a given candidate while avoiding the tendency to simply total the scores.

Referring still to FIG. 2, candidate evaluation engine 74 may further receive feedback data 78 related to follow-up on the success of candidates previously selected using the system. This feedback data 78 may be analyzed to produce the weight 60 referred to above reflecting actual experience with the importance of the identified traits and characteristics. This feedback data 78 may be taken from the scores of individuals having a positive post-interview experience, for example, a call back for a second interview or a positive hiring decision or from post-hiring activity such as evaluations by supervisors, longevity in the job, sales metrics, or the like. Generally, this information may be obtained through questionnaires from the employer.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”. “second” and other such numerical terms referring to structures do not imply a sequence or order unless clearly indicated by the context. The phrase “numeric” is intended to cover any representation that could be mapped to an ordinal set of numbers.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “computer” or “a processor” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. An apparatus for evaluating candidates for a target position comprising:
an input for receiving information describing qualifications for a given job from multiple different sources including at least one text job description;
a text processor processing the at least one text job description to provide numeric scores for predefined traits and competencies related to the at least one text job description;
a threshold processor receiving numeric scores for the predefined competency and traits derived from the multiple different sources to identify a subset of the predefined traits and competencies for the given job most related to the given job; and
a candidate evaluation module receiving the subset of the predefined traits and competencies for the given job and candidate information to evaluate the candidates against the subset of the predefined traits and competencies.

2. The apparatus of claim 1 wherein the threshold processor assesses a reliability of a primary source and weights the primary source in producing the numeric score according to its assessed reliability and wherein the primary source is a questionnaire collating system receiving input from multiple individuals to rank the given job with respect to the predefined traits and competencies and the reliability is assessed by a similarity in the rankings among the multiple individuals.

3. The apparatus of claim 2 wherein the assessed reliability is from predefined traits and competencies indicated to be essential by at least one of the multiple different sources.

4. The apparatus of claim 3 wherein some of the predefined traits and competencies are indicated to be undesirable and where in the subset of predefined traits and characteristics includes essential traits and characteristics only if they are identified as such by multiple different sources and includes undesirable traits and characteristics if they are identified by even one of the multiple individuals.

5. The apparatus of claim 1 wherein the text processor includes a dictionary of terms linked to the traits and competencies and analyzes text from at least one source of the multiple different sources using the dictionary to establish a numeric score for the at least one source.

6. The apparatus of claim 5 wherein the at least one source is a recruitment job description prepared by an institution seeking a candidate for the given job.

7. The apparatus of claim 6 wherein the at least one source is a government-produced standard job description.

8. The apparatus of claim 7 wherein the at least one source is the O*NET database.

9. The apparatus of claim 1 further including a questionnaire collating system receiving input from multiple individuals to rate the given job with respect to the predefined traits and competencies to provide numeric scores and at least one of the different sources providing numeric scores to the threshold processor is the questionnaire collating system.

10. The apparatus of claim 9 where the questionnaire collating system provides a server serving a questionnaire to multiple computer terminals associated with different individuals.

11. The apparatus of claim 1 wherein the threshold processor further includes an experience weight input receiving information about successful candidates and their associated traits and competencies to adjust weights attached to each of the traits and competencies serving to scale the numeric rankings of these traits and competencies.
